(19) United States
(12) Patent Application Publication
(10) Pub. No.: US 2022/0075039 A1
(43) Pub. Date: Mar. 10, 2022

(54) METHOD FOR CORRECTING NONLINEAR DISTANCE ERROR OF 3-DIMENSIONAL DISTANCE MEASURING CAMERA BY USING PULSE PHASE SHIFT

(71) Applicant: MEERE COMPANY INC., Hwaseong-si, Gyeonggi-do (KR)

(72) Inventor: Hyun Sung SON, Osan-si, Gyeonggi-do (KR)

(21) Appl. No.: 17/309,870

(22) PCT Filed: Jun. 12, 2019
(86) PCT No.: PCT/KR2019/017174

§ 371 Date: Jun. 24, 2021

(30) Foreign Application Priority Data
Dec. 26, 2018 (KR) 10-2018-0169224

(51) Int. Cl. G01S 7/497; G01S 7/4865; G01S 17/36; G01S 17/894

(52) U.S. Cl. CPC G01S 7/497; G01S 17/894; G01S 17/36; G01S 7/4865

(57) ABSTRACT

This application relates to a method of correcting a nonlinear distance error of a 3-dimensional distance measuring camera using a pulse phase shift. In one aspect, the method includes adjusting a phase of an output light pulse output from a light-emitting unit, outputting the phase-adjusted output light pulse to a subject, and receiving a reflected-light pulse reflected from the subject. The method may also include mapping the adjusted phase of the output light pulse to an estimated actual distance so as to correspond thereto and calculating a measured distance using a time difference between a time point at which the output light pulse is output and a time point at which the reflected-light pulse is received. The method may further include calculating and storing a distance-error correction value for correcting a difference between the estimated actual distance and the measured distance.

### TECHNICAL FIELD

The present disclosure relates to a method of correcting a nonlinear distance error of a 3-dimensional distance measuring camera using a pulse phase shift. More particularly, the present disclosure relates to a technique capable of correcting a nonlinear distance error of a 3-dimensional distance measuring camera through a pulse phase shift method at a fixed position, thereby overcoming space constraints generated in the process of correcting the nonlinear distance error of the 3-dimensional distance measuring camera, reducing equipment costs required for correcting the distance error, and shortening a distance-error correction time.

### BACKGROUND ART

A 3-dimensional distance measuring camera, such as a time of flight (TOF) camera or the like, is generally known.

FIG. 1 is a view illustrating a distance measuring principle of a conventional TOF camera, and FIG. 2 is a view illustrating a phase delay according to a distance in measuring the distance by the conventional TOF camera.

Referring to FIGS. 1 and 2, a 3-dimensional distance measuring camera such as a TOF camera or the like emits light to a subject, calculates the reflected and returned light through an equation using a sinusoidal phase, and converts a calculation result into distance information.

In the calculation process, there is a slight difference between the calculated distance and an actual distance due to the use of an incomplete sine wave, which is caused by hardware characteristics or the like, rather than a perfect sine wave, and the degree of the difference is varied depending on the distance, and thus there is a problem in that a nonlinear error whose level is different according to the distance is generated in the 3-dimensional distance measuring camera.

In order to correct the nonlinear error, the related art uses a method of installing a stage that allows a 3-dimensional distance measuring camera to move back and forth from a subject in a space equal to the entire measuring distance of the camera, performing distance measuring operations in a state in which the camera is positioned at a plurality of measuring points whose actual distances are known, and creating a look-up table that allows errors between a plurality of actual distances and measured distances to be corrected based on the measurement results.

FIG. 3 discloses measurement data in a case in which the nonlinear distance error is not corrected, according to the related art, and FIG. 4 discloses measurement data in a case in which the nonlinear distance error is corrected, according to the related art.

However, according to the related art, there is a problem in that as a measuring distance of the 3-dimensional distance measuring camera increases, a wider space is required for the measurement and a cost for installing the stage is high. In addition, there is a problem in that it takes a lot of time to correct the error of the camera because time is consumed in the process of moving the camera to a plurality of measuring points on the stage by an operator for the error measurement.

### PRIOR ART DOCUMENTS

Korean Patent Application Publication No. 10-2016-0054156 (Publication Date: May 16, 2016, Title: Distance Measuring Device).

Korean Patent Application Publication No. 10-2017-0051752 (Publication Date: May 12, 2017, Title: TOF Camera Control Method).

### DESCRIPTION OF EMBODIMENTS

### Technical Problem

A technical objective of the present disclosure is to overcome space constraints generated in a process of correcting a nonlinear distance error of a 3-dimensional distance measuring camera, reduce equipment costs required for correcting the distance error, and shorten a distance-error correction time by correcting the nonlinear distance error of the 3-dimensional distance measuring camera through a pulse phase shift method at a fixed position.

### Solution to Problem

A method of correcting distance nonlinearity of a 3-dimensional distance measuring camera using a pulse phase shift according to the present disclosure for solving these technical problems includes a phase adjusting step of adjusting a phase of an output light pulse output from a light-emitting unit by a control unit, a light emitting step of outputting the phase-adjusted output light pulse to a subject by the light-emitting unit, a light receiving step of receiving a reflected-light pulse reflected from the subject by a light-receiving unit, and a distance-error correction value calculating/storing step of mapping the adjusted phase of the output light pulse to an estimated actual distance so as to correspond thereto, calculating a measured distance using a time difference between a time point at which the output light pulse is output and a time point at which the reflected-light pulse is received, and calculating and storing a distance-error correction value for correcting a difference between the estimated actual distance and the measured distance, by the control unit.

The method of correcting distance nonlinearity of a 3-dimensional distance measuring camera using a pulse phase shift according to the present disclosure further includes, after the distance-error correction value calculating/storing step, a measurement completion-determining step of determining whether the measurement is completed by the control unit on the basis of whether the phase of the output light pulse is the same as a preset completion reference phase, wherein when it is determined in the measurement completion-determining step that the phase of the output light pulse is not the same as the completion reference phase, the step is switched to the phase adjusting step.

In the method of correcting distance nonlinearity of a 3-dimensional distance measuring camera using a pulse phase shift according to the present disclosure, in the phase adjusting step, the control unit delays the phase of the output light pulse by as much as a value that is obtained by dividing a period of the output light pulse by an equidistant interval.

In the method of correcting distance nonlinearity of a 3-dimensional distance measuring camera using a pulse phase shift according to the present disclosure, in the distance-error correction value calculating/storing step, the control unit stores the distance-error correction value in a look-up table format.

In the method of correcting distance nonlinearity of a 3-dimensional distance measuring camera using a pulse phase shift according to the present disclosure, the phase adjusting step, the light emitting step, the light receiving step, the distance-error correction value calculating/storing step, and the measurement completion-determining step are performed in a state in which a position of the 3-dimensional distance measuring camera is fixed.

In the method of correcting distance nonlinearity of a 3-dimensional distance measuring camera using a pulse phase shift according to the present disclosure, the control unit is embedded in the 3-dimensional distance measuring camera as FPGA IP (field-programmable gate array intellectual property), or is provided outside the 3-dimensional distance measuring camera and connected to the 3-dimensional distance measuring camera.

### Advantageous Effects of Disclosure

According to the present disclosure, there is an effect of overcoming space constraints generated in a process of correcting a nonlinear distance error of a 3-dimensional distance measuring camera, reducing equipment costs required for correcting the distance error, and shortening a distance-error correction time by correcting the nonlinear distance error of the 3-dimensional distance measuring camera through a pulse phase shift method at a fixed position.

Further, a method of correcting a nonlinear distance error using a pulse phase shift method of the present disclosure has an effect in which there are no space constraints as compared with the conventional method because a camera is fixed in a space of about one to two meters, at which light reflected from a subject is not saturated on a sensor surface.

Further, according to the present disclosure, instead of using a stage that moves a camera from a subject by as much as an actual measured distance, a device capable of shifting a phase of a light source, from which light is to be emitted to the subject, is mounted inside or outside the camera so that there is an effect that a cost for equipment required for the production is almost negligible.

Further, according to the present disclosure, measurement data is collected by changing only a phase of a pulse at a fixed position without moving an actual position, so that there is an effect in which an error correction time is greatly shortened as compared with the related art.

### BRIEF DESCRIPTION OF DRAWINGS

FIG. 1 is a view illustrating a distance measuring principle of a conventional time of flight (TOF) camera.

FIG. 2 is a view illustrating a phase delay according to a distance to a subject in measuring the distance by the conventional TOF camera.

FIG. 3 is a view illustrating measurement data in a state in which a nonlinear distance error is not corrected, according to the related art.

FIG. 4 is a view illustrating measurement data in a state in which the nonlinear distance error is corrected, according to the related art.

FIG. 5 is an exemplary functional block diagram of a device that performs a method of correcting a nonlinear distance error of a 3-dimensional distance measuring camera using a pulse phase shift, according to an embodiment of the present disclosure.

FIG. 6 is a view illustrating an actual configuration of the device that performs the method of correcting a nonlinear distance error of a 3-dimensional distance measuring camera using a pulse phase shift, according to an embodiment of the present disclosure.

FIG. 7 is a view illustrating the method of correcting a nonlinear distance error of a 3-dimensional distance measuring camera using a pulse phase shift, according to an embodiment of the present disclosure.

FIG. 8 is a view for describing an exemplary configuration of delaying a phase of an output light pulse, according to an embodiment of the present disclosure.

FIG. 9 is a view illustrating measurement data in a case in which a nonlinear distance error is not corrected, according to an embodiment of the present disclosure.

FIG. 10 is a view illustrating measurement data in a case in which the nonlinear distance error is corrected, according to an embodiment of the present disclosure.

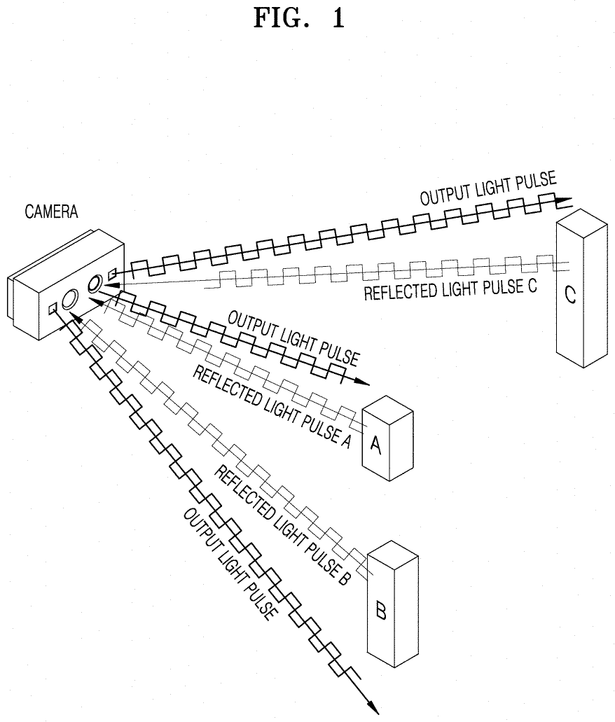

### MODE FOR THE DISCLOSURE

Specific structural or functional descriptions for the embodiments according to the concept of the present disclosure disclosed herein are merely exemplified for purposes of describing the embodiments according to the concept of the present disclosure, and thus the embodiments according to the concept of the present disclosure may be embodied in various forms but are not limited to the embodiments described herein.

While the embodiments of the present disclosure are susceptible to various modifications and alternative forms, specific embodiments thereof are shown by way of example in the drawings and will herein be described in detail However, it should be understood that there is no intent to limit the embodiments according to the concept of the present disclosure to the particular forms disclosed, but on the contrary, the present disclosure is to cover all modifications, equivalents, and alternatives falling within the spirit and scope of the present disclosure.

Although terms such as “first,” “second,” and the like may be used to describe various components, such components should not be limited to the above terms The terms are only used to distinguish one component from another. For example, a first component could be termed a second component, and, similarly, a second component could be termed a first component without departing from the scope of the present disclosure.

It should be understood that when a component is referred to as being “connected” or “coupled” to another component, the component may be directly connected or coupled to another component or intervening components may be present. Conversely, it should be understood that when a component is referred to as being “directly connected to” or “directly coupled to” another component, there are no intervening components present Further, other expressions describing the relationships between components should be interpreted in the same way (e.g., “between” versus “directly between,” “adjacent” versus “directly adjacent,” and the like).

The terms used herein are for the purpose of describing only specific embodiments and are not intended to limit the present disclosure. Unless the context clearly dictates otherwise, the singular form includes the plural form. It should be understood that terms “comprises,” “comprising,” “includes,” and/or “including” used herein specify the presence of stated features, integers, steps, operations, components, elements, and/or combinations thereof, but do not preclude the presence or addition of one or more other features, integers, steps, operations, components, elements, and/or combinations thereof.

Unless otherwise defined, all terms used herein including technical or scientific terms have the same meanings as those generally understood by one of ordinary skill in the art It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, exemplary embodiments of the present disclosure will be described in detail with reference to the accompanying drawings.

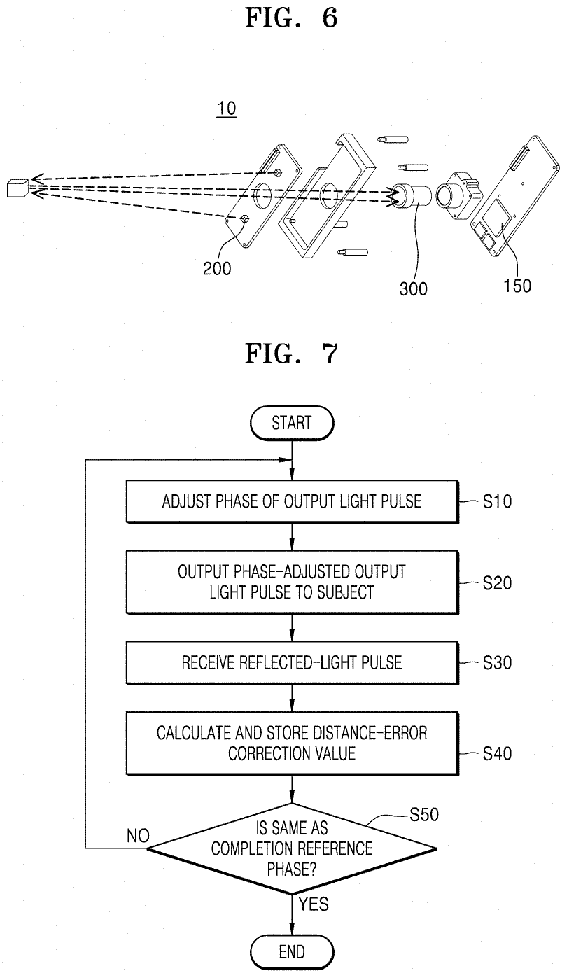

FIG. 5 is an exemplary functional block diagram of a device that performs a method of correcting a nonlinear distance error of a 3-dimensional distance measuring camera using a pulse phase shift, according to an embodiment of the present disclosure, FIG. 6 is a view illustrating an actual configuration of the device that performs the method of correcting a nonlinear distance error of a 3-dimensional distance measuring camera using a pulse phase shift, according to an embodiment of the present disclosure, and FIG. 7 is a view illustrating the method of correcting a nonlinear distance error of a 3-dimensional distance measuring camera using a pulse phase shift, according to an embodiment of the present disclosure.

Referring to FIGS. 5 to 7, the method of correcting a nonlinear distance error of a 3-dimensional distance measuring camera 10 using a pulse phase shift according to an embodiment of the present disclosure includes a phase adjusting step (S10), a light emitting step (S20), a light receiving step (S30), a distance-error correction value calculating/storing step (S40), and a measurement completion-determining step (S50).

In the phase adjusting step (S10), a process of adjusting a phase of an output light pulse, which is output from a light-emitting unit 200, by a control unit 150 is performed.

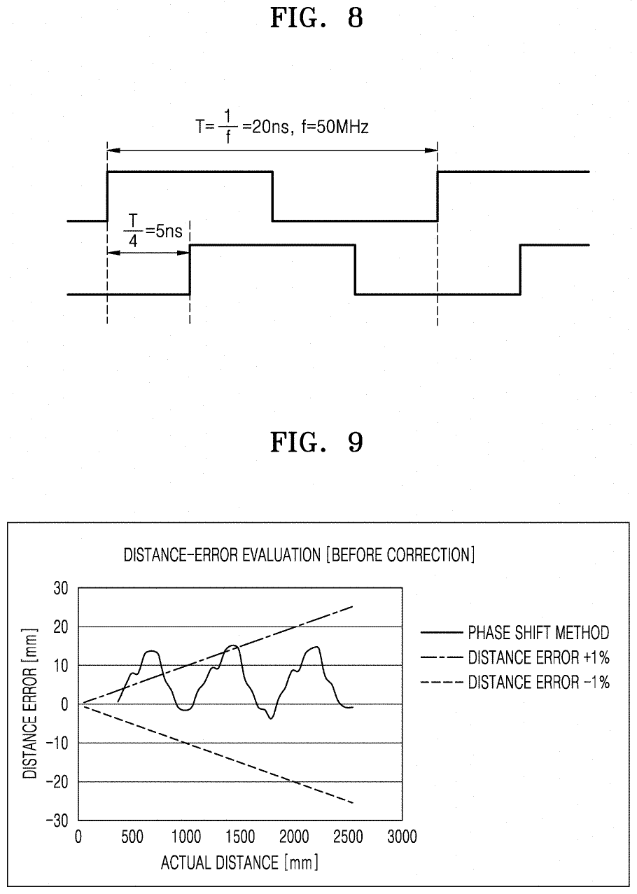

For example, in an embodiment of the present disclosure, referring additionally to FIG. 8, which is a view for describing an exemplary configuration of delaying the phase of the output light pulse, in the phase adjusting step (S10), the control unit 150 may be configured to delay the phase of the output light pulse by as much as a value obtained by dividing a period of the output light pulse by an equidistant interval. In FIG. 8, as an example, a modulation frequency f of the output light pulse is 50 MHz, and accordingly, a period T of the output light pulse is 20 ns, and a delay phase, that is, a value obtained by dividing the period of the output light pulse by an equidistant interval is 5 ns. Of course, this is merely one example for the description.

The reason for such a configuration and the effect thereof will be described as follows.

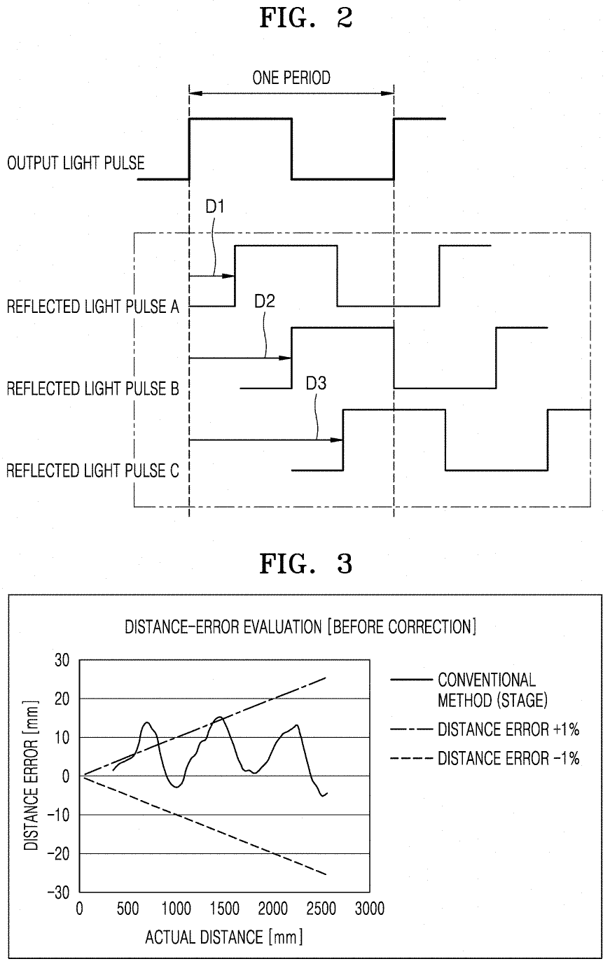

Although the description has been made with reference to FIG. 2 in the process of describing the related art, in the process of measuring a distance to a subject with the 3-dimensional distance measuring camera 10 including a time of flight (TOF) camera or the like to generate a depth map, an output light pulse output by the light-emitting unit 200 to the subject is reflected from the subject, a light-receiving unit 300 receives the reflected-light pulse reflected from the subject, and a phase of the reflected-light pulse received by the light-receiving unit 300 has a characteristic of being delayed in proportion to the distance to the subject.

According to an embodiment of the present disclosure, a nonlinear distance error of the 3-dimensional distance measuring camera 10 is corrected using a relationship between a distance to a subject and a phase delay of a pulse, and a configuration of emitting an output light pulse, whose phase is adjusted to correspond to an actual distance between the subject and the camera, to the subject while a position of the 3-dimensional distance measuring camera 10 is fixed at one specific point.

This configuration will be described in more detail below.

In the pulse phase shift method according to an embodiment of the present disclosure, a phase of a pulse emitted to a subject is shifted without physically changing a distance between the 3-dimensional distance measuring camera 10 and the subject, thereby changing the time taken for the pulse to be reflected and returned back to the actual subject. Using this principle, it is possible to obtain the effect of executing the measurement by changing the distance between the 3-dimensional distance measuring camera 10 and the subject without moving the physical position.

A maximum measurement distance (measurement range) of the 3-dimensional distance measuring camera 10 including a TOF camera is determined according to a modulation frequency used for light output, and a time length of one period of the modulation frequency may be matched with the actual distance, and the maximum measurement distance (measurement range) may be obtained by Equation 1 below.

### [Equation 1]

Maximum measurement distance (measurement range)=C/(2f), where C (luminous flux)=3×10¹¹ mm, and f is the modulation frequency

The time length of one period of the modulation frequency f is matched to the actual distance, and as illustrated in FIG. 8, when the phase of the pulse is shifted by T/4, the maximum measurement distance moves by ¼ of the measurement range.

For example, in a case in which the modulation frequency is 50 MHz, the measurement range is 3000 mm, and when the phase of the pulse is shifted by T/4, the maximum measurement distance moves by as much as 750 mm, which is ¼ of the measurement range.

With this principle, when phase values are measured while shifting one period T at an equidistant interval, an effect similar to that of using the stage according to the related art may be obtained.

According to such a configuration of the present disclosure, since the camera is fixed at a specific point of about one to two meters, in which light reflected from the subject, that is, the reflected-light pulse, is not saturated in an image sensor constituting the light-receiving unit 300, from the subject and used, there is an advantage in that there are no space constraint as compared with the related art in which the position of the camera is physically moved using the stage.

Further, according to the present disclosure, instead of using a stage that moves a camera from a subject by as much as an actual measured distance, a device capable of shifting a phase of a light source, from which light is to be emitted to the subject, is mounted inside or outside the camera so that there is an advantage in that a cost for equipment required for the production is almost negligible.

For example, the control unit 150 may be embedded in the 3-dimensional distance measuring camera 10 as FPGA IP (field-programmable gate array intellectual property), or may be configured to be connected to the 3-dimensional distance measuring camera 10 when the control unit 150 is provided outside the 3-dimensional distance measuring camera 10 to perform a distance-error correction operation.

In the light emitting step (S20), a process of outputting a phase-adjusted output light pulse to the subject by the light-emitting unit 200 is performed.

In the light receiving step (S30), a process of receiving a reflected-light pulse, which is reflected from the subject, by the light-receiving unit 300 is performed.

In the distance-error correction value calculating/storing step (S40), a process is performed in which the control unit 150 maps the adjusted phase of the output light pulse to an estimated actual distance so as to correspond thereto, calculates a measured distance using a time difference between a time point at which the output light pulse is output and a time point at which the reflected-light pulse is received, and calculates and stores a distance-error correction value for correcting the difference between the estimated actual distance and the measured distance.

For example, in the distance-error correction value calculating/storing step (S40), the control unit 150 may store the distance-error correction value in a look-up table format.

In the measurement completion-determining step (S50), a process of determining, by the control unit 150, whether or not the measurement is completed is performed based on whether the phase of the output light pulse is the same as a preset completion reference phase.

For example, it may be configured such that, when it is determined in the measurement completion-determining step (S50) that the phase of the output light pulse is not the same as the completion reference phase, the step is switched to the phase adjusting step (S10).

For example, the phase adjusting step (510), the light emitting step (520), the light receiving step (530), the distance-error correction value calculating/storing step (540), and measurement completion-determining step (550) may be performed in a state in which the position of the 3-dimensional distance measuring camera 10 is physically fixed.

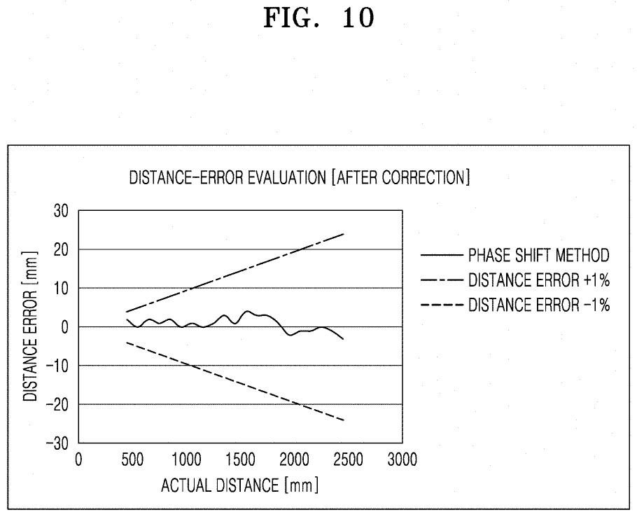

FIG. 9 is a view illustrating measurement data in a case in which the nonlinear distance error is not corrected, according to an embodiment of the present disclosure, and FIG. 10 is a view illustrating measurement data in a case in which the nonlinear distance error is corrected, according to an embodiment of the present disclosure.

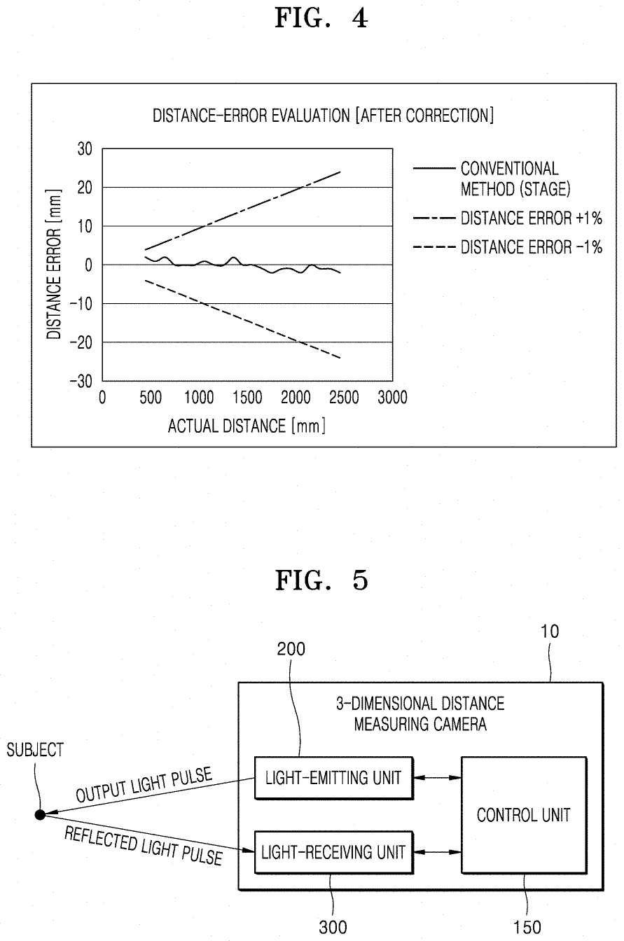

Referring additionally to FIGS. 9 and 10, it is may be confirmed that a distance-error correction similar or equivalent to the method, which uses a stage to change the distance between the camera and the subject, according to the related art disclosed in FIGS. 3 and 4 is achieved even in the case of shifting the phase to correspond to the actual distance without physically moving the position of the 3-dimensional distance measuring camera according to an embodiment of the present disclosure,

As described in detail above, according to the present disclosure, there is an effect of overcoming space constraints generated in a process of correcting a nonlinear distance error of the 3-dimensional distance measuring camera 10, reducing equipment costs required for correcting the distance error, and shortening an error correction time, by correcting the nonlinear distance error of the 3-dimensional distance measuring camera 10 through a pulse phase shift method at a fixed position.

Further, a method of correcting a nonlinear distance error using a pulse phase shift method of the present disclosure has an effect in which there are no space constraints as compared with the conventional method because a camera is fixed in a space of about one to two meters, at which light reflected from a subject is not saturated on a sensor surface.

Further, according to the present disclosure, instead of using a stage that moves a camera from a subject by as much as an actual measured distance, a device capable of shifting a phase of a light source, from which light is to be emitted to the subject, is mounted inside or outside the camera so that there is an effect that a cost for equipment required for the production is almost negligible.

Further, according to the present disclosure, measurement data is collected by changing only a phase of a pulse at a fixed position without moving an actual position, so that there is an effect in which an error correction time is greatly shortened as compared with the related art.

1. A method of correcting a nonlinear distance error of a 3-dimensional distance measuring camera using a pulse phase shift, the method comprising:
a phase adjusting step of adjusting a phase of an output light pulse output from a light-emitting unit by a control unit;
a light emitting step of outputting the phase-adjusted output light pulse to a subject by the light-emitting unit;
a light receiving step of receiving a reflected-light pulse reflected from the subject by a light-receiving unit; and
a distance-error correction value calculating/storing step of mapping the adjusted phase of the output light pulse to an estimated actual distance so as to correspond thereto, calculating a measured distance using a time difference between a time point at which the output light pulse is output and a time point at which the reflected-light pulse is received, and calculating and storing a distance-error correction value for correcting a difference between the estimated actual distance and the measured distance, by the control unit.

2. The method of claim 1, further comprising, after the distance-error correction value calculating/storing step, a measurement completion-determining step of determining whether the measurement is completed by the control unit on the basis of whether the phase of the output light pulse is the same as a preset completion reference phase, wherein, when it is determined in the measurement completion-determining step that the phase of the output light pulse is not the same as the completion reference phase, the measurement completion-determining step is switched to the phase adjusting step.

3. The method of claim 1, wherein, in the phase adjusting step, the control unit delays the phase of the output light pulse by as much as a value that is obtained by dividing a period of the output light pulse by an equidistant interval.

4. The method of claim 2, wherein, in the distance-error correction value calculating/storing step, the control unit stores the distance-error correction value in a look-up table format.

5. The method of claim 2, wherein the phase adjusting step, the light emitting step, the light receiving step, the distance-error correction value calculating/storing step, and the measurement completion-determining step are performed in a state in which a position of the 3-dimensional distance measuring camera is fixed.

6. The method of claim 1, wherein the control unit is embedded in the 3-dimensional distance measuring camera as FPGA IP (field-programmable gate array intellectual property), or is provided outside the 3-dimensional distance measuring camera and connected to the 3-dimensional distance measuring camera.
